(19) United States
(12) Patent Application Publication
(10) Pub. No.: US 2023/0177670 A1
(43) Pub. Date: Jun. 8, 2023

(54) INFORMATION PROCESSING APPARATUS AND METHOD OF SETTING INSPECTION CONDITION OF IMAGE

(71) Applicant: CANON KABUSHIKI KAISHA, Tokyo (JP)

(72) Inventor: Hiroki SATO, Ibaraki (JP)

(21) Appl. No.: 17/993,074

(22) Filed: Nov. 23, 2022

(30) Foreign Application Priority Data
Dec. 7, 2021 (JP) 2021-198705

(51) Int. Cl. G06T 7/00; G06T 7/70

(52) U.S. Cl. CPC G06T 7/0004; G06T 7/70; G06T 2207/30144

(57) ABSTRACT

An information processing apparatus includes a designation unit configured to designate an inspection area included in an image on a sheet; a controller configured to obtain reading data related to the image on the sheet, wherein the reading data is output by a reading device; obtain sheet type information related to a type of the sheet on which the image is formed; determine, based on the sheet type information, a range which is selectable as a determination condition used for inspection of an image of the inspection area; obtain user instruction information related to the determination condition selected from the range; determine the determination condition to be used for the inspection based on the user instruction information; and inspect color of the image of the inspection area based on the determination condition and the reading data.

### BACKGROUND OF THE INVENTION

### Cross-Reference to Priority Application

This application claims the benefit of Japanese Patent Application No. 2021-198705, filed Dec. 7, 2021, which is hereby incorporated by reference herein in its entirety.

### Field of the Invention

The present disclosure relates to an information processing apparatus to inspect color of an image printed on a printed material and a method of setting an inspection condition of an image.

### Description of the Related Art

As to an image forming apparatus that performs image forming using an electrophotographic process, characteristics of the processes (such as charging, developing, transferring, and fixing) may vary due to temporal changes in parts and changes in an environment, as a result, an image density and a color of the printed material may change. Therefore, the image forming apparatus performs an image stabilization control. The image stabilization control is, for example, a control in which a test image, formed on an image bearing member, for detecting an image density is detected, and based on its detection result, an image forming condition is adjusted to obtain an appropriate image density of the image on the image bearing member. The image forming condition includes various settings at the time of image forming, such as a charge amount of an image carrier, and a light emission energy amount of a laser that scans the image carrier.

Since the image stabilization control is a control for a process before transferring an image on a recording sheet, the image stabilization control cannot control an influence on image density generated in a process after the transfer. For example, the image stabilization control does not support a change of transfer efficiency due to environmental changes at the time of transferring a toner image from the image carrier to the recording sheet. Thus, variations may occur in the image density of the image finally formed on the recording sheet. In this regard, the image formed on the recording sheet is detected by a photo sensor to perform control for adjusting an image forming condition based on the detection result is performed.

Japanese Patent Application Laid-open No. 2019-080327 describes an image reading apparatus for performing colorimetric analysis for an image formed on a recording sheet. The image reading apparatus reads an adjustment chart on which a test image for adjusting an image forming condition to feedback a reading result to the image forming condition. Further, the image reading apparatus may be used as an inspection apparatus for printed material for determining, from a reading result of an image (hereinafter, “user image”) specified by a user by a print job, whether the color deviates from that specified by the user.

As described above, the inspection apparatus for printed material performs inspection by comparing the color designated by a user with the color of the actually created printed material to thereby confirm that there is no discrepancy. When a color is set using L, a, b coordinate values in Lab color space, it is difficult to continue a stable output of the printed material so that the values are exactly the same. Therefore, a certain amount of variation will arise in color of the printed material.

Thus, the inspection apparatus needs to provide a threshold value for the determination so that the difference between numerical values within a predetermined range may be permitted. However, as to the color of the image on printed material, the variation in color of the printed material changes according to surface nature of the recording sheet used for printing or color of the recording sheet itself. For example, for a recording sheet with a low degree of whiteness such as a special paper with patterns, or recycled paper, the variation in color of printed material becomes large. Therefore, if the same threshold is used to determine the color of the printed material of different sheet types, almost all printed materials may be determined that their color deviates from the color designated by the user.

### SUMMARY OF THE INVENTION

An information processing apparatus according to the present disclosure includes: a designation unit configured to designate an inspection area included in an image on a sheet; a controller configured to: obtain reading data related to the image on the sheet, wherein the reading data is output by a reading device; obtain sheet type information related to a type of the sheet on which the image is formed; determine, based on the sheet type information, a range which is selectable as a determination condition used for inspection of an image of the inspection area; obtain user instruction information related to the determination condition selected from the range; determine the determination condition to be used for the inspection based on the user instruction information; and inspect color of the image of the inspection area based on the determination condition and the reading data.

Further features of the present invention will become apparent from the following description of exemplary embodiments (with reference to the attached drawings).

### BRIEF DESCRIPTION OF THE DRAWINGS

FIG. 1 is an explanatory configuration diagram of a print system.

FIG. 2 is a configuration diagram of an image forming apparatus.

FIG. 3 is an explanatory configuration diagram of a reader.

FIG. 4 is an exemplary diagram of a controller.

FIG. 5 is a flow chart representing a setting process for a parameter.

FIG. 6A and FIG. 6B are explanatory diagrams of the screen displayed on a display upon performing the setting process.

FIG. 7 is an exemplary diagram of the screen displayed on the display upon performing the setting process.

FIG. 8 is an exemplary diagram of the screen displayed on the display upon performing the setting process.

FIG. 9 is a flow chart representing the setting process for a parameter.

### DESCRIPTION OF THE EMBODIMENTS

At least one embodiment of the present disclosure is described below in detail with reference to the drawings. It should be noted that the following embodiment is not intended to limit the scope of the invention described in the attached claims, and not all combinations of the features described in the embodiments are essential for means for solving the invention.

### Print System

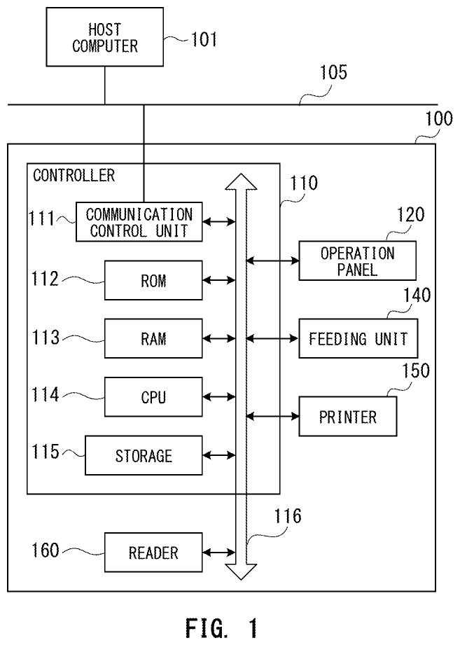

FIG. 1 is an explanatory configuration diagram of a printing system having an inspection apparatus according to the present embodiment. The printing system includes an image forming apparatus 100 and a host computer 101. The image forming apparatus 100 and the host computer 101 are communicably connected to each other via the network 105. The network 105 includes, for example, a communication line such as a local area network (LAN), a wide area network (WAN), and a public communication line. A plurality of the image forming apparatuses 100 and a plurality of the host computers 101 may be connected to the network 105, respectively.

The host computer 101 is, for example, a server apparatus, and is configured to transmit a print job to the image forming apparatus 100 via the network 105. The print job includes various information necessary for printing such as image data, a type of recording sheet used for printing, the number of sheets to be printed, and instructions for double-sided or single-sided printing.

The image forming apparatus 100 includes a controller 110, an operation panel 120, a feeding unit 140, a printer 150, and a reader 160. The controller 110, the operation panel 120, the feeding unit 140, the printer 150, and the reader 160 are communicably connected to each other via a system bus 116. The image forming apparatus 100 controls the operation of the printer 150 based on the print job obtained from the host computer 101, and forms an image corresponding to the image data on the recording sheet.

The controller 110 controls the operation of each unit of the image forming apparatus 100. The controller 110 is an information processing device including a read only memory (ROM) 112, a random access memory (RAM) 113, and a central processing unit (CPU) 114. The controller 110 includes a communication control unit 111 and a storage 115. Each module is communicably connected to each other via the system bus 116. In the present embodiment, the controller 110 and the reader 160 function as an inspection apparatus which inspects color of an image of printed material generated by the printer 150.

The communication control unit 111 is a communication interface which communicates with the host computer 101 and other devices via the network 105. The storage 115 is a large-capacity storage device such as an HDD (Hard Disk Drive), SSD (Solid State Drive), or the like. The storage 115 stores various data used for a computer program and an image forming process (printing process). The CPU 114 executes a computer program stored in the ROM 112 or the storage 115 to control the operation of the image forming apparatus 100. The RAM 113 provides a work area for the CPU 114 to execute a computer program.

The operation panel 120 is a user interface having an input interface and an output interface. The input interface is, for example, operation buttons, a numeric keypad, a touch panel, or the like. The output interface is, for example, a display such as Liquid Crystal Display (LCD) etc., a speaker, etc. The user can input the print job, a command, print settings, and the like to the image forming apparatus 100 using the operation panel 120. The operation panel 120 displays the setting screen and the status of the image forming apparatus 100 on the display.

The feeding unit 140 includes a plurality of sheet feeding cassettes, which will be described later, for accommodating the recording sheet. Each sheet feeding cassette may accommodate the recording sheet of the same type, however, it may accommodate different types of the recording sheet. The feeding unit 140 feeds the recording sheet of the type instructed by the print job from the feeding cassettes in which the recording sheet is accommodated. A plurality of the recording sheets (a bundle of recording sheets) are stored in the sheet feeding cassette, and the recording sheets are fed in order from the topmost recording sheet. The feeding unit 140 conveys the recording sheet fed from the sheet feeding cassette to the printer 150.

The printer 150 prints an image on the recording sheet fed from the feeding unit 140 based on image data included in the print job to generate a printed material. The reader 160 is an image reading apparatus which reads an image from the printed material generated by the printer 150 and transmits its reading result to the controller 110.

### Image Forming Apparatus

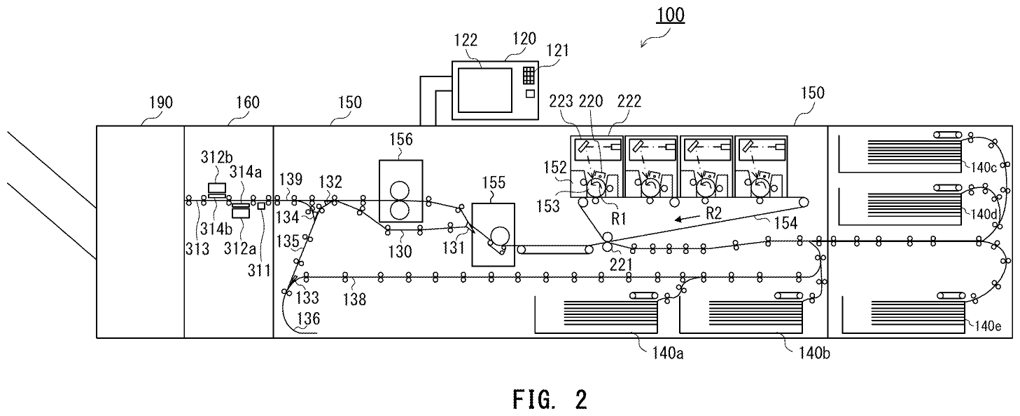

FIG. 2 is a configuration diagram of the image forming apparatus 100. The image forming apparatus 100 includes sheet feeding cassettes 140a to 140e, a printer 150, a reader 160, and a finisher 190 in this order from the upstream side in a conveyance direction of the recording sheet. The sheet feeding cassettes 140a to 140e constitute the feeding unit 140. The finisher 190 is a post-processing device which performs post-processing of the printed material printed by the printer 150. The finisher 190 performs, for example, staple processing, sort processing, and the like for a plurality of the printed materials. The operation panel 120 is provided on an upper portion of the printer 150. The operation panel 120 includes operation buttons 121 as the input interface, and includes a display 122 as the output interface.

The printer 150 includes a plurality of image forming units 222 which form images of different colors. The printer 150 of the present embodiment includes four image forming units 222 for forming images of four colors of yellow (Y), magenta (M), cyan (C), and black (K). Each image forming unit 222 only differs in the color of the image to be formed, and performs the same operation with the same configuration.

One image forming unit 222 includes a photosensitive drum 153, a charger 220, an exposure device 223, and a developing device 152. The photosensitive drum 153 is a drum-shaped photosensitive member having a photosensitive layer on its surface, and is rotationally driven by a motor (not shown) in the direction of an arrow R1. The charger 220 charges a surface (photosensitive layer) of the rotating photosensitive drum 153. The exposure device 223 exposes the charged surface of the photosensitive drum 153 with a laser beam. The laser beam scans the surface of the photosensitive drum 153 in a direction of an axis of the photosensitive drum 153. A direction in which the laser beam scans the surface of the photosensitive drum 153 is a main scanning direction of the printer 150 (depth direction in FIG. 2). As a result, an electrostatic latent image is formed on the surface of the photosensitive drum 153. The developing device 152 develops the electrostatic latent image using a development agent (toner). As a result, an image (the toner image) in which the electrostatic latent image is visualized is formed on the surface of the photosensitive drum 153.

The printer 150 includes an intermediate transfer belt 154 onto which a toner image generated in each image forming unit 222 is transferred. The intermediate transfer belt 154 is rotationally driven in the direction of an arrow R2. The toner image of each color is transferred at a timing according to the rotation of the intermediate transfer belt 154. Thus, a full-color toner image is formed on the intermediate transfer belt 154 in which the toner images of the respective colors are superimposed. The full-color toner image is conveyed, as the intermediate transfer belt 154 rotates, to a nip portion formed by the intermediate transfer belt 154 and the transfer roller 22. The full-color toner image is transferred to the recording sheet at the nip portion.

The recording sheets are accommodated in the sheet feeding cassettes 140a, 140b, 140c, 140d, and 140e of the feeding unit 140, and the recording sheet is fed according to the timing of image forming by each image forming unit 222. The sheet feeding cassette from which the recording sheet is fed is specified by the print job. The recording sheet is conveyed to the nip portion at the timing when the full-color toner image is conveyed to the nip portion. As a result, the toner image is transferred to a predetermined position on the recording sheet. A conveyance direction of the recording sheet is a sub-scanning direction which is orthogonal to the main scanning direction.

The printer 150 includes a first fixing unit 155 and a second fixing unit 156 which fixes the toner image on the recording sheet by heating and pressurizing. The first fixing unit 155 includes a fixing roller in which a heater is installed and a pressure belt for pressing the recording sheet against the fixing roller to thereby contact the recording sheet with the fixing roller. The fixing roller and the pressure belt are driven by a motor (not shown) to sandwich and convey the recording sheet to perform fixing processing onto the recording sheet. By being sandwiched and conveyed by the fixing roller and the pressure belt, the toner image is fixed onto the recording sheet. The second fixing unit 156 is arranged on the downstream side of the first fixing unit 155 in the conveyance direction of the recording sheet. The second fixing unit 156 is used to increase the gloss of the image on the recording sheet which has passed the first fixing unit 155 and to secure the fixing characteristic. The second fixing unit 156 includes a fixing roller in which a heater is installed and a pressure roller in which a heater is installed. The fixing roller and the pressure roller sandwich and convey the recording sheet to perform fixing processing onto the recording sheet. According to the type of recording sheet, the second fixing unit 156 may not be used. In this case, the recording sheet is not conveyed to the second fixing unit 156, but is conveyed to a sheet conveyance path 130. For this reason, a flapper 131 is provided on the downstream side of the first fixing unit 155 to guide the recording sheet to either the sheet conveyance path 130 or the second fixing unit 156.

A conveyance path 135 and a discharge path 139 are formed on the downstream side of a position on the downstream side of the second fixing unit 156 where the conveyance path 130 joins. Therefore, a flapper 132 for guiding the recording sheet to either the conveyance path 135 and the discharge course 139 is formed at a position, in the lower stream side of the second fixing unit 156, where the conveyance path 130 merges. The flapper 132 guides, for example, in a double-sided printing mode, the recording sheet, which has a first surface on which an image has been formed, to the conveyance path 135. The flapper 132 guides, for example, in a face-up discharging mode, the recording sheet, which has a first surface on which an image has been formed, to the discharge path 139. The flapper 132 guides, for example, in a face-down discharging mode, the recording sheet, which has a first surface on which an image has been formed, to the sheet conveyance path 135.

The recording sheet conveyed to the conveyance path 135 is conveyed to a reversing section 136. The recording sheet conveyed to the reversing section 136 is switched back to reverse the conveyance direction after the conveyance operation is temporarily stopped. A recording sheet is guided, from the reversal unit 136, to either of the conveyance path 135 and a conveyance path 138 by the flapper 133. The flapper 133 guides, for example, in the double-sided printing mode, the switched back recording sheet to the sheet conveyance path 138 in order to print an image on a second surface of the recording sheet. The recording sheet conveyed to the conveyance path 138 is conveyed towards a nip portion of the intermediate transfer belt 154 and the transfer roller 221. As a result, the front and back sides of the recording sheet when passing through the nip portion are reversed, and the image is formed on the second surface. The flapper 133 guides, for example, in the face-down discharging mode, the switched back recording sheet to the sheet conveyance path 135. The recording sheet conveyed by the flapper 133 to the conveyance path 135 is guided to the discharge path 139 by the flapper 134.

The recording sheet, after forming the image by the printer 150, is conveyed from the discharge path 139 to the reader 160. The reader 160 reads an inspection area of a user image printed on the recording sheet according to the print job. The inspection area, settings for color information, and a method for determining a threshold for color determination are described later. The recording sheet conveyed from the printer 150 to the reader 160 is conveyed to a conveyance path 313 in the reader 160. The reader 160 includes an original detection sensor 311 and line sensor units 312a, 312b in the conveyance path 313. Between the line sensor units 312a, 312b and the conveyance path 313, flow reading glass plates 314a and 314b are arranged. The reader 160 reads the recording sheet on which the user image has been printed by the printer 150 by the line sensor units 312a, 312b while conveying the recording sheet to the conveyance path 313. The reader 160 functions as a reading device.

The original detection sensor 311 is, for example, an optical sensor having a light emitting element and a light receiving element. The original detection sensor 311 detects a tip, in the conveyance direction, of the recording sheet conveyed in the conveyance path 313. A detection result of the tip of the recording sheet by the original detection sensor 311 is transmitted to the controller 110. The controller 110 starts a reading operation by the reader 160 (line sensor units 312a, 312b) based on a detection timing of the tip of the recording sheet detected by the original detection sensor 311.

The line sensor units 312a, 312b read, via flow reading glass plates 314a, 314b, the user image printed on the printed material. The line sensor unit 312a and the line sensor unit 312b are arranged with the conveyance path 313 in between. By providing the line sensor unit 312a and the line sensor unit 312b, even in a case where the inspection areas are set both sides of the recording sheet, it is possible to read the user image.

The controller 110 obtains a result of colorimetric analysis of the inspection areas in the user images on the front and back surfaces of the printed material by the line sensor units 312a, 312b. The controller 110 controls an image forming condition based on the result of colorimetric analysis so that the images (printed images) of the printed materials output from the printer 150 have an appropriate color. Further, the controller 110 separates and discharges printed material which has created with inappropriate color (NG product) from normal printed material which has created with an appropriate color. For this purpose, the controller 110 causes the finisher 190 to sort and discharge the printed materials to different discharge trays according to the inspection result of the printed materials. The controller 110 determines the color based on the result of colorimetric analysis for inspecting the printed material.

### Reader

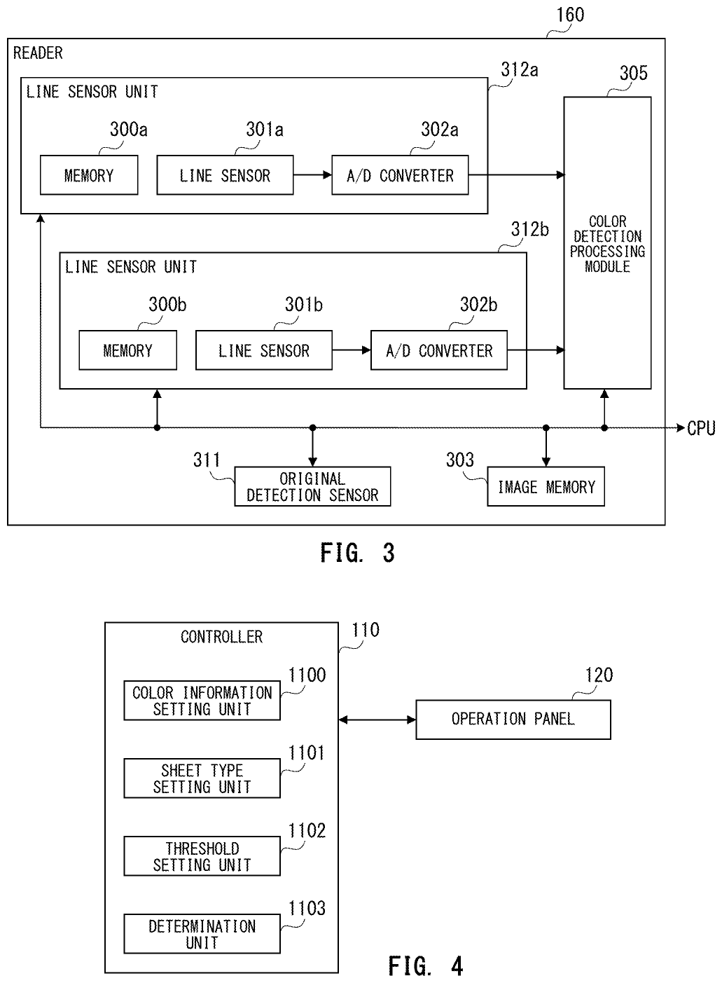

FIG. 3 is an explanatory configuration diagram of the reader 160. The reader 160 includes, in addition to the line sensor units 312a, 312b and the original detection sensor 311, an image memory 303 and a color detection processing module 305.

The line sensor units 312a, 312b include line sensors 301a, 301b, memories 300a, 300b, and AD converters 302a, 302b. The line sensors 301a, 301b are, for example, contact image sensors (CIS). The memories 300a and 300b store correction information such as variations in an amount of light between corresponding pixels of the line sensors 301a and 301b, steps between pixels, and distances between pixels. AD converters 302a, 302b obtains analog signals that are results of reading by line sensors 301a, 301b. The AD converters 302a, 302b convert the obtained analog signals into digital signals and transmit the digital signals to the color detection processing module 305. The digital signal is read data of R (red), G (green), and B (blue). The read data is not limited to R (red), G (green), and B (blue) data, and may be data of yellow, cyan, and magenta. The read data is data corresponding to the reading result of the image output from the reader 160.

The color detection processing module 305 includes semiconductor devices such as field-programmable gate array (FPGA) and application specific integrated circuit (ASIC). The color detection processing module 305 acquires an average value of brightness (average brightness value) for each color of the inspection area from the reading data of RGB obtained from the line sensor units 312a, 312b to transmit the average brightness value to the CPU 114. The operations of the line sensor units 312a, 312b, the image memory 303, the color detection processing module 305, and the original detection sensor 311 are controlled by the CPU 114 of the controller 110. The image memory 303 stores image data necessary for image processing by the CPU 114.

### Setting for Colorimetric Analysis

A setting for colorimetric analysis is performed using the operation panel 120 or the host computer 101 as an input device. By performing the setting for colorimetric analysis, the inspection area, the setting of the color information to be measured, and the method of determining the threshold for color determination are set. Hereinafter, an example of performing the setting for colorimetric analysis in the controller 110 using the operation panel 120 will be described. FIG. 4 is an explanatory diagram of the controller 100.

The controller 110 functions as a color information setting unit 1100, a sheet type setting unit 1101, a threshold setting unit 1102, and a determination unit 1103 by executing computer programs stored in the ROM 112 by the CPU 114. The color information setting unit 1100 sets the color information of the inspection area based on information input from the operation panel 120. The sheet type setting unit 1101 sets the sheet type information of the recording sheet used for the printed material to which the colorimetric analysis is performed based on the information input from the operation panel 120. The threshold setting unit 1102 sets a threshold range based on the sheet type information set by the sheet type setting unit 1101. The threshold range is a range set within a range of the threshold for color determination from a color value indicated by the image data. The determination unit 1103 inspects the image formed on the printed material based on the threshold for color determination and a result of the colorimetric analysis. Specifically, the determination unit 1103 determines whether the color of the image formed on the printed material is within the threshold range. Based on a detection result of the determination unit 1103, it is determined whether an image with an appropriate color is formed on the printed material or the NG product is formed on the printed material. Specifically, in a case where the result of the colorimetric analysis falls within the threshold range, the printed material is determined to have an image with appropriate color. In a case where the result of the colorimetric analysis does not fall within the threshold range, the printed material is determined to be the NG product.

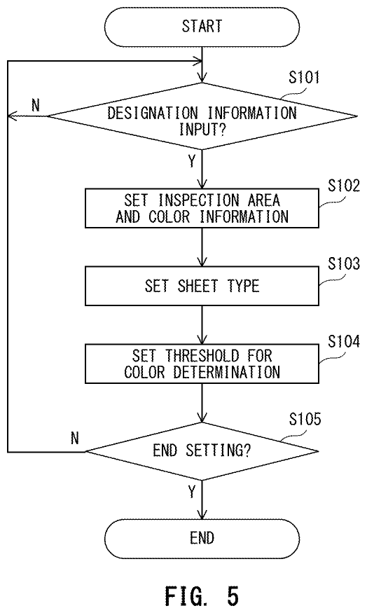

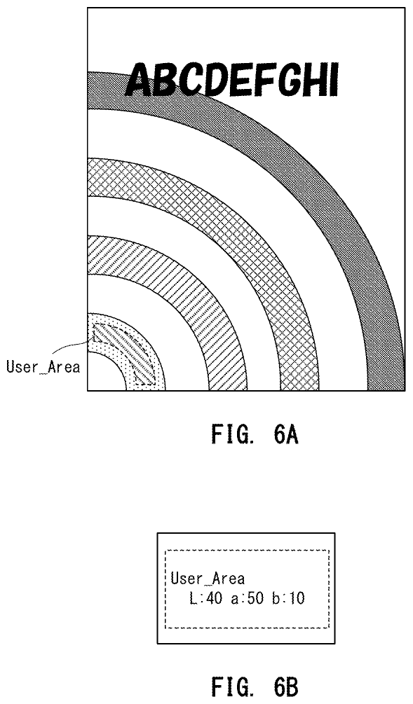

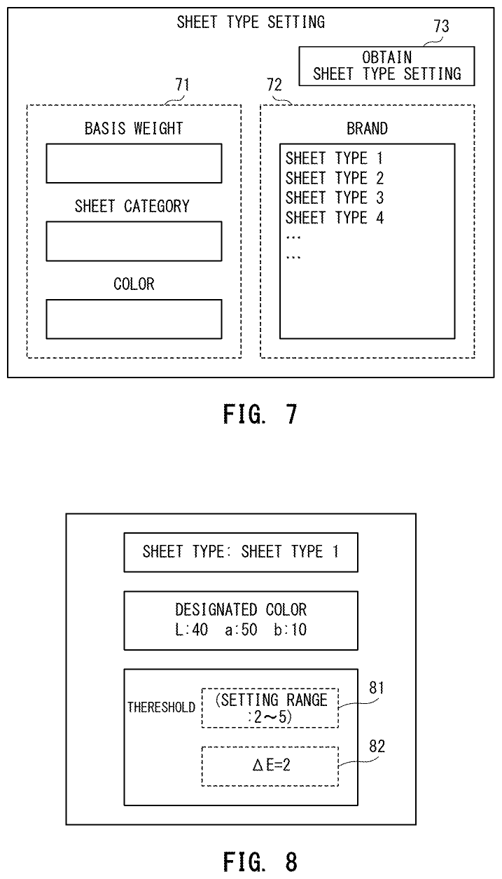

FIG. 5 is a flow representing a setting process for a parameter necessary for colorimetric analysis, such as an inspection area, color information related to a target color of an image in the inspection area, and the threshold for color determination. FIG. 6A, FIG. 6B, FIG. 7, and FIG. 8 are exemplary diagrams of screens displayed on the display 122 of the operation panel 120 during the setting process. This processing is performed when the print job is input to the image forming apparatus 100.

The controller 110 displays a screen on the display 122 of the operation panel 120 to prompt the user to select an area and a color to which the colorimetric analysis is to be performed. The controller 110 displays this screen and waits for input of designation information designating the inspection area and the target color (Step S101: N). Here, screens exemplified in FIG. 6A and FIG. 6B are displayed. FIG. 6A represents an image based on image data included in the print job. FIG. 6B represents color information display section indicating color information. When the user selects an inspection area from the image represented in FIG. 6A based on the image data, the controller 110 controls the color information setting unit 1100 to display the color information of the selected inspection area in the color information display section of FIG. 6B. In FIG. 6A, “User_Area” is selected as the inspection area, and in FIG. 6B, “L: 40 a: 50 b: 10” is displayed as the color information. It should be noted that the user can directly designate, by directly inputting the color information to the color information display section using the operation panel 120, the color to which the colorimetric analysis is performed. By inputting a numerical value in the color information display section, the inspection area corresponding to the color is highlighted in the image based on the image data. The designated information is input in this way.

When the designation information is input (Step S101: Y), the controller 110 sets the inspection area and the color information by the color information setting unit 1100 based on the input designation information (Step S102). The operation panel 120 functions as a designation unit which designates the inspection area. The inspection area and the color information are set in the color detection processing module 305 of the reader 160. The color detection processing module 305 acquires, based on the inspection area and the color information which are set by the color detection processing module 305, an average brightness value for each color of the inspection area from the reading data of RGB obtained from the line sensor units 312a, 312b to transmit the average brightness value to the CPU 114. In this embodiment, the color information is L*, a*, b* coordinate value in the Lab color space. In addition, the color information is not limited to the coordinate value of the Lab color space, but is a coordinate value in arbitrary color space.

After setting the inspection area and the color information, the controller 110 displays a sheet type setting screen on the display 122 of the operation panel 120 to prompt the user to set the type of recording sheet to be used for printing. The controller 110 sets the sheet type using the sheet type setting unit 1101 based on the input content via the sheet type setting screen (Step S103). The setting contents are stored in the RAM 113, for example. FIG. 7 is an exemplary diagram of the sheet type setting screen. There are three methods for setting the sheet type.

The first setting method is a method in which the sheet type is input by inputting parameters in a setting area 71. Parameters to be input in the setting area 71 include basis weight, a sheet category (including a type of processing performed on the sheet surface), and color. A numerical value is entered as the basis weight. In the input area of the sheet category, approximate types of sheet such as plain paper, coated paper, embossed paper, recycled paper, colored paper, etc., are displayed, from which the appropriate one is selected. Color is set when colored paper is selected in the sheet category. The second setting method is to designate a brand from a list of sheet types displayed in a setting area 72. The third setting method is a method of obtaining the sheet type information set in the print job by pressing a button 73.

After the sheet type is set, the controller 110 displays a threshold setting screen on the display 122 of the operation panel 120 to prompt the user to set the threshold for color determination. The threshold for color determination is a value for the determination unit 1103 to determine whether to determine the printed material as the NG product based on a deviation amount between a result of the colorimetric analysis of the printed material and the designated color. The determination unit 1103 obtains, for example, an average luminance value from the color detection processing module 305, and compares this average luminance value with the threshold for color determination to thereby calculate the deviation amount of the result of the colorimetric analysis of the printed material for the designated color. The controller 110 uses the threshold setting unit 1102 to set a threshold in the determination unit 1103 based on the input content from the threshold setting screen (Step S104). FIG. 8 is an exemplary view of a threshold setting screen.

On the threshold setting screen, the color information (designated color) set in the processing of Step S102 and the sheet type set in the processing of Step S103 are displayed. A setting range 81 within which a threshold can be set is displayed on the threshold setting screen. The setting range 81 is previously predetermined according to the sheet type and is stored in the ROM 112. Based on the sheet type information obtained from the sheet type setting unit 1101, the threshold value setting unit 1102 reads a setting range information of the corresponding sheet type from the ROM 112 to display the setting range 81. Here, for example, in a case where the sheet type information indicates plain paper, as to the lower limit of the setting range 81, ΔE is 2 or less, and in a case where the sheet type information indicates recycled paper, as to the lower limit of the setting range 81, ΔE is 3 or less. Further, for example, when the sheet type information indicates coated paper or embossed paper, as to the lower limit of the setting range 81, ΔE is 3.5 or less.

A numerical value for the threshold for color determination is input in the setting area 82. The threshold for color determination is set with ΔE, which represents the color difference in Lab space. It is noted that ΔE corresponds to a distance between the color to be inspected and the target color in the color space. In the setting area 82, numerical values outside the range represented by the setting range 81 cannot be input. Thus, in the setting area 82, only numerical values within the range represented by the setting range 81 can be input. The setting range 81 is a range which can be selected as a determination condition used for inspection. The controller 110 determines the setting range 81 based on the aforementioned sheet type information. The controller 110 obtains the value of ΔE selected by the user from the setting range 81. The value of ΔE selected by the user corresponds to user designated information.

In a case where the threshold for color determination is set, the controller 110 displays a screen asking whether there are other colors to which the colorimetric analysis is to be performed on the display 122 of the operation panel 120. The controller 110 determines whether or not to end the setting process for the colorimetric analysis based on the display of this screen (Step S105). If there are other colors that the user wishes to perform the colorimetric analysis (Step S105: N), the controller 110 repeats the process of Step S101 and its subsequent processes again. If there is no other color that the user wishes to perform the colorimetric analysis (Step S105: Y), the controller 110 ends the setting process for the colorimetric analysis.

In a case where the print job instructs image forming of a plurality of pages, the controller 110 switches the image shown in FIG. 6A and then performs the processing shown in FIG. 5 again. Further, even if the print job instructs image forming on multiple types of paper, the controller 110 can execute the process shown in FIG. 5 multiple times to thereby set the threshold for color determination for each type of paper. Then, the controller 110 inspects the printed material using the value of ΔE selected by the user as the determination condition. If the color difference between the result of the colorimetric analysis and the target color is equal to or less than the threshold, the controller 110 determines that the product has an appropriate color. On the other hand, if the color difference is greater than the threshold, the controller 110 determines that the color of the product is not appropriate.

### Modification Example

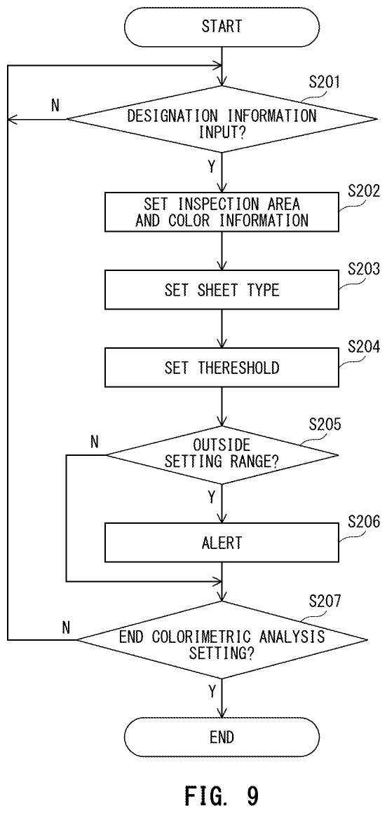

FIG. 9 is a flowchart showing a modification example of the setting process for the parameter required for the colorimetric analysis. The process from waiting for input of the designation information to setting of a sheet type is the same as the processes of Steps S101 to S103 in FIG. 5 (Steps S201 to S203). In a case where the sheet type is set, the controller 110 displays the threshold setting screen of FIG. 8 on the display 122 of the operation panel 120. However, in the modification example, numerical values outside the range represented by the setting range 81 of the threshold for color determination can be input in the setting area 82. Therefore, the controller 110 determines whether the threshold for color determination input in the setting area 82 is outside the setting range (Step S205).

If it is not within the setting range (Step S205: Y), the controller 110 displays an alert on the display 122 of the operation panel 120 (Step S206). The alert is, for example, a message indicating that “Because it is out of the setting range, NG products may be increased”. After displaying the alert, the controller 110 determines whether or not to end the setting process for the colorimetric analysis in the same manner as in the process of Step S105 in FIG. 5 (Step S207). If it is within the set range (Step S205: N), the controller 110 performs the process of Step S207 without displaying the alert. The controller 110 may display, after displaying the alert, a setting screen to prompt resetting of the threshold for color determination on the display 122.

If there are other colors that the user wishes to perform the colorimetric analysis (Step S207: N), the controller 110 repeats the process of Step S201 and its subsequent processes again. If there is no other color that the user wished to perform colorimetric analysis (Step S207: Y), the controller 110 ends the setting process for the colorimetric analysis.

Although the processes of FIG. 5 and FIG. 9 are performed by the controller 110, these processes may be performed by the host computer 101. In this case, the host computer 101 includes the functions of the color information setting unit 1100, the sheet type setting unit 1101, and the threshold setting unit 1102. Further, a user interface having an input interface and an output interface is connected to the host computer 101. Thus, the host computer 101 is configured to perform the process of FIG. 5 or FIG. 9 while communicating with the controller 110 through the network 105. In addition, the controller 110 may display each screen of FIG. 6A, FIG. 6B, FIG. 7, and FIG. 8 on a display of the host computer 101. In this case, the controller 110 sets parameters required for colorimetric analysis according to the input from a host computer 101.

As described above, according to the present disclosure, the threshold for color determination for suitable colorimetric analysis can be set for each type of sheet. Therefore, the influence of the sheet type on the inspection of the printed material is suppressed, and it is possible to determine the color with high accuracy and perform accurate inspection.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An information processing apparatus comprising:
a designation unit configured to designate an inspection area included in an image on a sheet;
a controller configured to:
obtain reading data related to the image on the sheet, wherein the reading data is output by a reading device;
obtain sheet type information related to a type of the sheet on which the image is formed;
determine, based on the sheet type information, a range which is selectable as a determination condition used for inspection of an image of the inspection area;
obtain user instruction information related to the determination condition selected from the range;
determine the determination condition to be used for the inspection based on the user instruction information; and
inspect color of the image of the inspection area based on the determination condition and the reading data.

2. The information processing apparatus according to claim 1,
wherein the determination condition is a condition related to difference between the color of the image of the inspection area and a target color.

3. The information processing apparatus according to claim 1,
wherein the determination condition is a condition related to a distance between the color of the image of the inspection area and a target color in a color space.

4. The information processing apparatus according to claim 1,
wherein the controller is configured to obtain image data input to an image forming apparatus to form the image on the sheet, and
wherein the controller is configured to inspect the color of the image of the inspection area based on the determination condition, the reading data, and the image data.

5. The information processing apparatus according to claim 1,
wherein the designation unit designates the inspection area based on color information related to the color to be inspected.

6. The information processing apparatus according to claim 1,
wherein the controller is configured to determine, based on the sheet type information, a lower limit of the range which is selectable as the determination condition used for inspection of the image of the inspection area.

7. The information processing apparatus according to claim 1,
wherein the controller is configured to determine the lower limit of the range as a first value in a case where the sheet type information is a first type, and
wherein the controller is configured to determine the lower limit of the range as a second value which is different from the first value in a case where the sheet type information is a second type which is different from the first type.

8. The information processing apparatus according to claim 1,
wherein the sheet type information includes basis weight of the sheet.

9. The information processing apparatus according to claim 1,
wherein the sheet type information includes color of the sheet.

10. The information processing apparatus according to claim 1,
wherein the sheet type information includes a type of processing performed on the surface of the sheet.

11. A method of setting an inspection condition of an image comprising:
reading an image on a sheet;
designating an inspection area included in an image on the sheet;
obtaining sheet type information related to a type of the sheet;
determining, based on the sheet type information, a range which is selectable as a determination condition used for inspection of an image of the inspection area;
selecting the determination condition from the range;
inspecting color of the image of the inspection area based on the selected determination condition and a reading result of the image.

12. The method according to claim 11,
wherein the determination condition is a condition related to difference between the color of the image of the inspection area and a target color.

13. The method according to claim 11,
wherein the determination condition is a condition related to a distance between the color of the image of the inspection area and a target color in a color space.

14. The method according to claim 11, further comprising:
obtaining image data input to an image forming apparatus to form the image on the sheet, and
inspecting color of the image of the inspection area based on the selected determination condition and a reading result of the image and the image data.

15. The method according to claim 11, further comprising:
designating color to be inspected, and
determining the inspection area based on the designated color.

16. The method according to claim 11, further comprising:
determining, based on the sheet type information, a lower limit of a range which is selectable as a determination condition used for inspection of an image of the inspection area.

17. The method according to claim 11, further comprising:
determining the lower limit of the range as a first value in a case where the sheet type information is a first type, and
determining the lower limit of the range as a second value which is different from the first value in a case where the sheet type information is a second type which is different from the first type.

18. The method according to claim 11, further comprising:
wherein the sheet type information includes basis weight of the sheet.

19. The method according to claim 11, further comprising:
wherein the sheet type information includes color of the sheet.

20. The method according to claim 11, further comprising:
wherein the sheet type information includes a type of processing performed on the surface of the sheet.
